(19) United States
(12) Patent Application Publication
(10) Pub. No.: US 2014/0161117 A1
(43) Pub. Date: Jun. 12, 2014

(54) eNB Enforced TAT Expiry/TA Validity

(71) Applicants: Benoist Pierre Sebire, Tokyo (JP); Chunli Wu, Beijing (CN); Claudio Rosa, Randers (DK)

(72) Inventors: Benoist Pierre Sebire, Tokyo (JP); Chunli Wu, Beijing (CN); Claudio Rosa, Randers (DK)

(73) Assignee: Nokia Siemens Networks Oy, Espoo (FI)

(21) Appl. No.: 14/234,678

(22) PCT Filed: Jul. 26, 2011
(86) PCT No.: PCT/CN2011/077613

§ 371 Date: Jan. 24, 2014

(51) Int. Cl. H04W 56/00

(52) U.S. Cl. CPC H04W 56/0005
USPC 370/350

(57) ABSTRACT

An apparatus includes an interface connectable to a network, and a controller configured to control a network including UE(s). An uplink connection of the UE(s) is configured on component carrier(s), and a timing advance related instruction with respect to the component carrier(s) is sent to the UE(s), by which validity of the timing advance is changed. An apparatus includes an interface connectable to a network, wherein an uplink connection of the apparatus is configured on component carrier(s), the interface being configured to receive a timing advance related instruction. A controller is configured to change a timing advance validity with respect to the component carrier(s) in response to receiving the timing advance related instruction. Likewise, corresponding methods and computer program products are proposed.

### FIELD OF THE INVENTION

The present invention relates to apparatuses, methods and a computer program product by which an eNB enforced TAT (timing advance timer) expiry/TA (timing advance) validity is enabled.

### RELATED BACKGROUND ART

The following meanings for the abbreviations used in this specification apply:
3GPP 3^{rd} generation partnership project
CA Carrier Aggregation
CC Component Carrier
CQI Channel Quality Indicator
DL Downlink
eNB Enhanced Node-B, LTE base station
LTE Long Term Evolution
vMAC Medium Access Control
MAC CE MAC Control Element
NAS Non-Access Stratum
PCell Primary Cell
PDCCH Physical Downlink Control CHannel
PUCCH Physical Uplink Control CHannel
RACH Random Access CHannel
RRH Remote Radio Head
SCell Secondary Cell
SRS Sounding Reference Signal
TA Timing Advance
TAC Timing Advance Command
TAT Timing Advance Timer
UE User equipment
UL Uplink

Embodiments of the present invention relate to radio network systems such as LTE (Long Term Evolution). In order to compensate for propagation delays in LTE, a timing advance (TA) is signalled by the eNB to the UE. When receiving a timing advance command (TAC), the UE adjusts its uplink transmission timing. A timing advance command can be received in a random access response or in a MAC control element. The validity of a timing advance command is controlled by the timing advance timer (TA timer, TAT). As long as the TA timer is running, the timing advance remains valid and uplink transmissions can take place on the shared channel. Every time a timing advance command is received, the TA timer is restarted. When the TA timer expires, uplink synchronization is required and no uplink transmission can take place on the shared channel. In order for the eNB to assess the timing adjustment needed at the UE, a random access procedure is usually started.

Release 10 of the E-UTRA specifications introduces Carrier Aggregation (CA), where two or more component carriers (CCs) are aggregated in order to support wider transmission bandwidths up to 100 MHz. In CA it is possible to configure a UE to aggregate a different number of CCs originating from the same eNodeB (eNB) and of possibly different bandwidths in the uplink (UL) and downlink (DL). When in CA, a UE is always configured with a primary cell (PCell). The PCell is used for security, NAS mobility, transmission of physical uplink control channel (PUCCH). All other configured CCs are called secondary cells (SCells). In addition to carrier aggregation, Rel-10 introduces the possibility to de-activate CCs in order to reduce the UE power consumption. The UE monitoring activity of a de-activated carrier is reduced (e.g. neither PDCCH monitoring nor CQI measurements) and the UL activity in a de-activated carrier is also stopped (no SRS). However, Rel-10 only supports deactivation of SCells and the UE-specific PCell is always assumed to be activated. In Rel-10, the uplinks of all serving cells are governed by the same timing advance: the TA of the PCell.

In Rel-11, support of the use of multiple timing advances in case of LTE uplink carrier aggregation is specified as one of the objectives. Multiple TA is needed to cope with e.g. non-collocated receivers on the network side i.e. for the RRH and frequency selective repeaters scenarios.

FIGS. 1A and 1B show two scenarios, which reproduce scenarios #4 and #5 listed in Table 11-1 (CA Deployment Scenarios) of 3GPP TS 36.300 V10.4.0 (2011 June). In detail, FIG. 1A shows a case in which F1 provides macro coverage and on F2 Remote Radio Heads (RRHs) are used to improve throughput at hot spots. Mobility is performed based on F1 coverage. Likely scenario is when F1 and F2 are of different bands, e.g., F1={800 MHz, 2 GHz} and F2={3.5 GHz}, etc. It is expected that F2 RRHs cells can be aggregated with the underlying F1 macro cells.

FIG. 1B shows a case in which F1 and F2 cells are co-located and overlaid, but F2 has smaller coverage due to larger path loss. Only F1 provides sufficient coverage and F2 is used to improve throughput. Mobility is performed based on F1 coverage. Likely scenario when F1 and F2 are of different bands, e.g., F1={800 MHz, 2 GHz} and F2={3.5 GHz}, etc. In FIG. 1B, frequency selective repeaters are deployed so that coverage is extended for one of the carrier frequencies. It is expected that F1 and F2 cells of the same eNB can be aggregated where coverage overlaps.

Currently, it is conceived to introduce the concept of TA group which is a set of serving cells with uplink resource sharing the same TA value. It is not concluded if we will have per UE TAT (timing advance timer) for all the groups or one TAT per group:
per UE TAT: the same timing advance timer applies to all serving cells and all TA groups
per group TAT: one timing advance timer is running per TA group

For both concepts there might occur problems in certain situations, as described in the following.

For example, when using the concept of per UE TAT, there is some period when an SCell requiring different TA is configured, it does not have UL sync yet but the per UE TAT is running (for instance due to already ongoing PCell activity). SRS transmission on such SCells should be prevented. It is not so according to current specification if the TAT for the UE is already running and periodic SRS resource is configured.

When using the concept of per group TAT, it is currently considered that there is no need to have different parameter for TAT value. However, to save UE power, there could be some cases where SRS transmission on SCell is not needed, but the eNB might still want to schedule DL of the SCell (for asymmetric traffic), thus deactivate the SCell would not serve the purpose. It would be good to have some way to dynamically stop UL transmission on the SCell under eNB control, without releasing the semi-statically configured UL resources.

Thus, in both concepts flexibility in uplink resources management is limited.

### SUMMARY OF THE INVENTION

The present invention addresses the problems described above and proposes in exemplary embodiments, new solutions which allow more flexibility in uplink resources management.

According to a first aspect of the present invention, there is provided
an apparatus comprising an interface connectable to a network, and a controller configured to control a network including at least one user equipment, wherein an uplink connection of the at least one user equipment is configured on at least one component carrier, and to send a timing advance related instruction with respect to the at least one component carrier to the at least one user equipment, by which validity of the timing advance is changed;
and
a method comprising controlling a network including at least one user equipment, wherein an uplink connection of the at least one user equipment is configured on at least one component carrier, and sending a timing advance related instruction with respect to the at least one component carrier to the at least one user equipment, by which validity of the timing advance is changed.

Advantageous further developments are as set out in respective dependent claims thereof.

According to a second aspect of the present invention, there is provided
an apparatus comprising an interface connectable to a network, wherein an uplink connection of the apparatus is configured on at least one component carrier, the interface being configured to receive a timing advance related instruction, and a controller configured to change a timing advance validity with respect to the at least one component carrier in response to receiving the timing advance related instruction;
and
a method comprising receiving a timing advance related instruction, wherein an uplink connection is configured on at least one component carrier, and changing a timing advance validity with respect to the at least one component carrier in response to receiving the timing advance related instruction.

Advantageous further developments are as set out in respective dependent claims thereof.

According to a third aspect of the present invention, there are provided computer program products comprising computer-executable components which, when executed on a computer, are configured to implement the respective methods as set out herein above. The above computer program product/products may be embodied as a computer-readable storage medium.

Hence, an improvement is achieved by those apparatuses, methods and computer program products, in that at least in connection with exemplary embodiments uplink transmission can easily be suspended when necessary by sending a timing advance related instruction to change TA validity (i.e. to make it invalid or valid, e.g. by a specific explicit command or e.g. by forcing a TAT timer to expire) to a user equipment.

Thus, more flexibility in uplink resources management can be achieved, and power saving at the user equipment is possible.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIGS. 1A and 1B show two scenarios in which RRHs are provided in order to extend the coverage of macro cells,

FIG. 2 shows an eNB according to an embodiment of the present invention,

FIG. 3 shows an UE according to an embodiment of the present invention,

FIG. 4 shows a signalling diagram according to a first solution according to embodiments of the present invention, and

FIG. 5 shows a signalling diagram according to a second solution according to embodiments of the present invention.

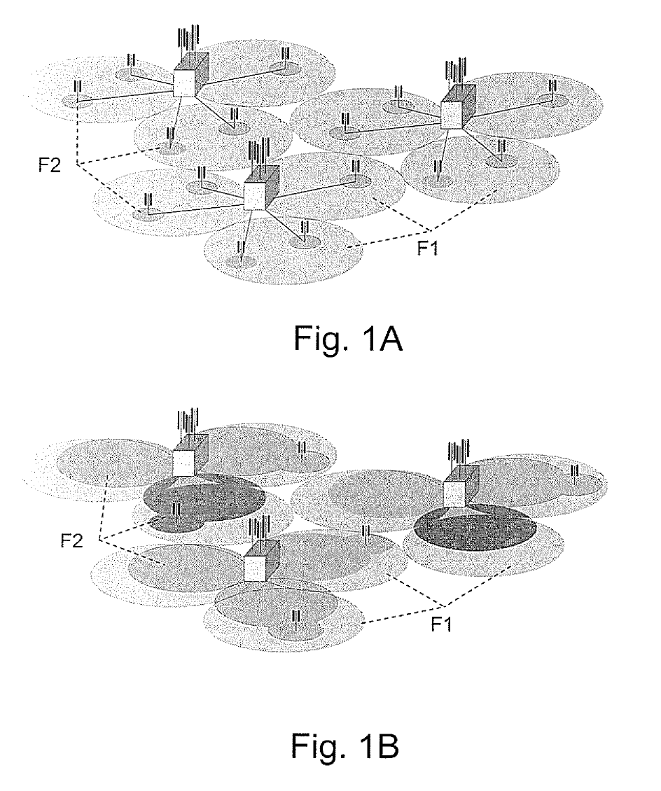

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

It is to be noted that the following exemplary description refers to an environment of the LTE system (long term evolution) and/or local area networks thereof. However, it is to be understood that this serves for explanatory purposes only.

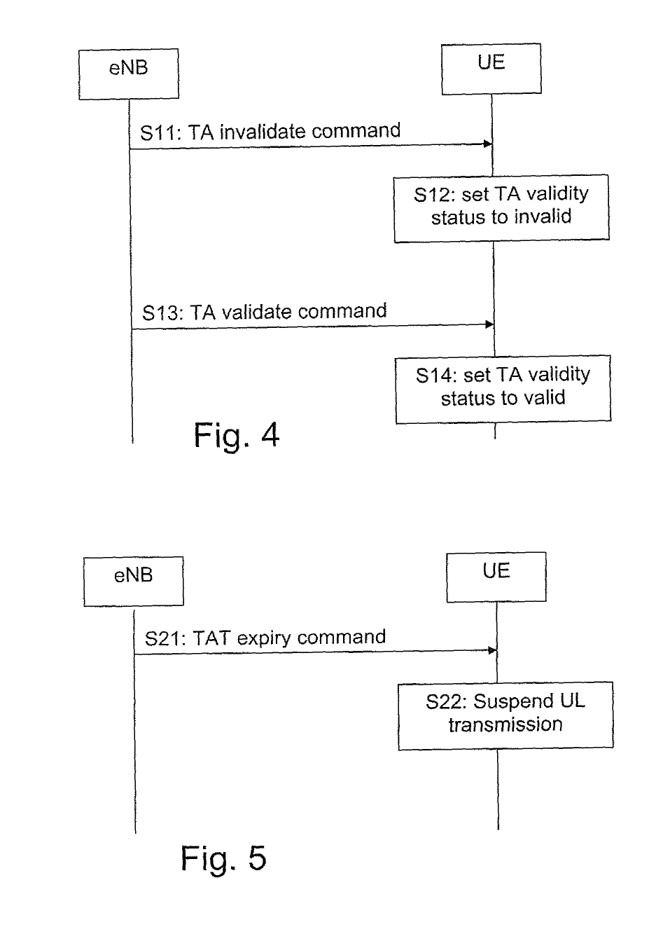

According to a general embodiment of the present invention, a timing advance related instruction by which validity of the TA is changed is sent from an eNB to an UE for an uplink connection which is configured on at least one component carrier or cell. The timing advance related instruction may be
(with reference to FIG. 4) TA (timing advance) (in)validity command for setting a TA (timing advance) validity status at the UE to invalid or valid, or
(with reference to FIG. 5) a TAT (timing advance timer) expiry command to enforce expiry of a TAT timing advance timer), for example, as will be explained in the following in more detail.

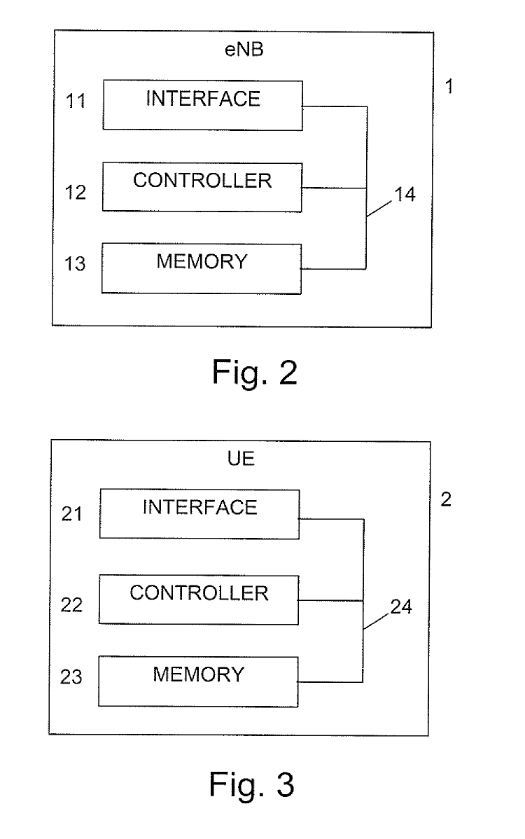

An example for a first apparatus according to an embodiment of the present invention is shown in FIG. 2. FIG. 2 illustrates a simplified block diagram of an eNB 1 according to an embodiment of the present invention. It is noted that the eNB, and the corresponding first apparatus according to the embodiment may consist only of parts of the eNB, so that the apparatus may be installed in an eNB, for example. Moreover, also the eNB is only an example and may be replaced by another suitable network control node, such as a base station or the like.

The eNB 1 comprises an interface 11 connectable to a network, and a controller 12 configured to control the network including at least one user equipment, wherein an uplink connection of the at least one user equipment is configured on at least one component carrier or cell. The controller 12 is configured to send the above-mentioned timing advance related instruction that changes timing advance validity with respect to the at least one component carrier to the at least one user equipment, for example via the interface 11.

The eNB 1 may also comprise a memory 13 in which programs for carrying out the functions according to the embodiment are stored. The interface 11, the controller 12 and the memory 13 may be inter-connected by a suitable connection 14, e.g., a bus or the like.

FIG. 3 shows a user equipment (UE) 2 as an example for a second apparatus according to an embodiment of the present invention. The UE 2 comprises an interface 21 connectable to a network, wherein an uplink connection of the apparatus is configured on at least one component carrier or cell. The interface is further configured to receive the timing advance related instruction mentioned above. The UE 2 further comprises a controller 22 which is configured to (under one aspect, cf. FIG. 4) make a timing advance valid or invalid, or (under another aspect, cf. FIG. 5) to force the TA timer to expire, with respect to the at least one component carrier or at least a group of CCs/Cells in response to receiving the timing advance related instruction.

Similar as the eNB 1 described above, the UE 2 may also comprise a memory 23 in which programs for carrying out the functions according to the embodiment are stored. The interface 21, the controller 22 and the memory 23 may be inter-connected by a suitable connection 24, e.g., a bus or the like.

As mentioned above, examples for the timing advance related instruction may be a TA (in)validity command for setting a TA validity status for at least one CC/Cell or at least a group of CCs/Cells at the UE to invalid or valid, or a TAT expiry command to enforce expiry of a TAT at for at least one CC/Cell or at least a group of CCs/Cells. These two solutions are described in the following in more detail.

In particular, according to the first solution, a TA validity status for each cell/group is introduced.

In this case, the eNB can send a TA invalidity command to prevent UL transmission on certain cell/group. The eNB can send a validity command to resume UL transmission without RACH procedure if it knows the UE is still in UL sync (uplink synchronization) since it received the last TA, otherwise use PDCCH order to initiate RACH.

A basic procedure according to this approach is illustrated in the signaling diagram shown in FIG. 4. In step S11, the eNB (e.g., eNB 1 shown in FIG. 2) sends the TA invalidity command to the UE (e.g., UE 2 shown in FIG. 3). In response to this, the UE sets the TA validity status to invalid in step S12. As a consequence, transmission on the uplink connection on the corresponding cell or component carrier is not possible. That is, UL transmission is suspended.

When, for example, the eNB determines that UL transmission of the UE on the cell should be allowed, then the eNB sends a TA validate command (validity command) mentioned above to the UE, as shown in step S13. In step S14, the UE sets in response to this TA validate command, the TA validity status to valid. Thus, transmission can immediately be resumed (if no RACH procedure or the like is necessary, as described above).

The default status for the TA validity status is invalid for an SCell which requires a new TA (new group). On the other hand, the default status for the TA validity status is valid for an SCell which already belongs to an UL in sync group (group of Scells which are in uplink synchronization). Thus the default status is valid for PCell and the SCells belonging to the same TA group as the PCell.

According to an alternative, TA validity is only introduced for TA groups with SCells only. That is, in this case no TA validity status is defined for the PCell (primary cell or primary component carrier).

As mentioned above, the validity (i.e. the TA validity status) is set to valid when the UE gets a TA command from the eNB so that UL transmission can be resumed (via RACH procedure, or TA Command MAC CE, or TA validity command.)

It is noted that there is no UL transmission when the TA validity status is invalid.

At the UE, a so-called UE calculation solution can be used to obtain the TA. In this case, the UE calculates the timing advance of SCells that do not have the same timing advance as the PCell based on the timing advance of the PCell and the downlink timing difference between the PCell and the SCell measured by the UE. Also in such a case, the UE should maintain a TA validity status to ensure no SRS transmission on the SCell before it already obtained UL TA for the SCell (based on certain criteria).

Thus, for the first solution, the UE maintains TA validity status for each cell/group, in addition to maintaining the TAT timer(s).

In an implementation of the first solution described above, a new MAC CE (control element) could be defined for the TA validity command. One bit for each group, for TA validity command, e.g. the bit set to 1 indicates the TA validity of the group (cells within the group) is set to valid, and 0 indicates the TA validity of the group (cells within the group) is set to invalid;

According to the second solution, a TAT expiry command to enforce TAT to expire for each cell/group is introduced.

In particular, consider the cells in the group as UL out of sync (uplink out of synchronization), UL transmission on the cells (compound carriers) in the group is prevented upon reception of the TAT expiry command for the group. The TAT expiry command should preferably be introduced with per group TAT.

If the TA expiry command is per UE, consider all the serving cells as UL out of sync, UL transmission is prevented upon reception of the TAT expiry command for the UE.]

Upon receiving TAT expiry command the UE can either:
release SRS/PUCCH resources configured on the corresponding cells, or
keep the configured resources though UL transmission is temporarily suspended

The UL resources (e.g. periodic SRS) can be kept upon TAT expiry of SCells.

UL sync can be resumed by RACH procedure e.g. initiated by PDCCH order from NW.

A basic procedure according to this approach is illustrated in the signaling diagram shown in FIG. 5. In step S21, the eNB (e.g., eNB 1 shown in FIG. 2) sends the TAT expiry command to the UE (e.g., UE 2 shown in FIG. 3). In response to this, the UE suspends UL transmission on the configured cell(s) or component carrier(s) as described above, in step S22 (or alternatively, as described above, the UE releases the resources configured on the corresponding cells and stop UL transmissions),

In an implementation of the second solution described above, similar as in connection with the first solution, a new MAC CE could be defined for the TAT expiry command. One bit for each group, for TAT expiry command, e.g. the bit set to 1 indicates to enforce the TAT expiry of the corresponding group, 0 indicates no action.

Furthermore, according to an alternative of the above-described first and second solutions, the TA validity/TAT expiry command is only introduced for TA groups with SCells only.

Thus, according to the embodiments described above, more flexibility in UL resources management can be achieved at the eNB side. On the UE side power saving can be achieved.

Moreover, the eNB can configure the periodic SRS resource when configuring an SCell, without worrying SRS transmission when the UE does not obtain UL sync yet while the per UE TAT is running.

The eNB can send the command to stop SRS transmission whenever it does not intend to schedule UL on the SCell for long time. PDCCH order initiated RACH could be used to resume UL, or TA validity command could be used to change the TA validity status to valid if the eNB knows the UE is still in sync since it received the last TA. Thus the eNB would have full control of when to stop/resume UL transmission. RACH on PCell could still work the same as Rel-10 so that UL data arrival case would not be delayed.

As the ACK/NACK and CQI of the SCell will be transmitted on PCell, DL of the SCell still works even if we force the TAT to expire for the SCell/group.

The present invention is not limited to the embodiments described above. For example, the TA invalidity command and the TAT expiry command are only examples for a timing advance related instruction. Other examples are also possible by which it is achieved that the timing advance and/or the timing advance timer is made invalid, either temporarily or permanently.

Furthermore, the two solutions described above can be combined. That is, a UE may maintain a TA validity status which can be validated/invalidated by a corresponding command from the eNB, but also a TAT expiry command may be sent to the UE in order to make the TA invalid (enforce UL out of sync).

Moreover, embodiments of the present invention were described by referring to LTE. However, the invention is not limited to this, and can be applied to any communication scheme in which a carrier aggregation or a similar measure can be applied and only a single uplink connection is available.

Generally, the invention is implemented in an environment such as LTE system adopting a local area scenario. Exemplary embodiments of the invention are represented by methods and/or correspondingly configured apparatuses such as eNBs and/or UEs. More specifically, the invention generally relates to modules of such devices. Other systems can benefit also from the principles presented herein.

Embodiments of the present invention may be implemented in software, hardware, application logic or a combination of software, hardware and application logic. The software, application logic and/or hardware generally, but not exclusively, may reside on the devices' modem module.

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular but without limitation to mobile communications, for example to environments under LTE, WCDMA, WIMAX and WLAN and can advantageously be implemented in user equipments or smart phones, or personal computers or personal digital assistants PDA's connectable to such networks. That is, it can be implemented as/in chipsets to connected/connectable devices, and/or modems or other modules thereof.

If desired, at least some of different functions discussed herein may be performed in a different order and/or concurrently with each other. Furthermore, if desired, one or more of the above-described functions may be optional or may be combined.

As has been disclosed herein above, this invention addresses an eNB enforced TAT expiry/TA validity and proposes, under an eNB aspect, an apparatus comprising an interface connectable to a network, and a controller configured to control a network including at least one user equipment, wherein an uplink connection of the at least one user equipment is configured on at least one component carrier, and to send a timing advance related instruction with respect to the at least one component carrier to the at least one user equipment, by which validity of the timing advance is changed, and, under an UE aspect, an apparatus comprising an interface connectable to a network, wherein an uplink connection of the apparatus is configured on at least one component carrier, the interface being configured to receive a timing advance related instruction, and a controller configured to change a timing advance validity with respect to the at least one component carrier in response to receiving the timing advance related instruction. Likewise, corresponding methods and computer program products at eNB and UE, respectively, are proposed.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising
an interface connectable to a network, and
a controller configured to
control a network including at least one user equipment, wherein an uplink connection of the at least one user equipment is configured on at least one component carrier, and
to send a timing advance related instruction with respect to the at least one component carrier to the at least one user equipment, by which validity of the timing advance is changed,

2. The apparatus according to claim 1, wherein
the timing advance related instruction is a timing advance invalidity command for setting a timing advance validity status of the at least one user equipment as invalid, by which the timing advance is made invalid.

3. The apparatus according to claim 1, wherein
the controller maintains a timing advance validity status, and the timing advance related instruction is a timing advance validity command for setting the timing advance status as valid by which the timing advance is made valid.

4. The apparatus according to claim 2, wherein
the controller is configured to send a timing advance command to the user equipment for setting the timing advance validity status as valid.

5. The apparatus according to claim 4, wherein
the timing advance command is a timing advance MAC control element or a timing advance in a random access response.

6. The apparatus according to claim 3, wherein
the controller is configured to determine whether the at least one user equipment is in uplink synchronization, and, when the at least one user equipment is in uplink synchronization, to send a timing advance validate command as the timing advance command to the at least one user equipment.

7. The apparatus according to claim 6, wherein
the controller is configured to, when it is determined that the at least one user equipment is not in uplink synchronization, send the timing advance command to the at least one user equipment using a random access channel procedure.

8. The apparatus according to claim 2, wherein
a timing advance value is defined for a group of component carriers on which uplink connections for the apparatus are configured and for which the at least one user equipment uses the same timing advance value.

9. The apparatus according to claim 1,
wherein the timing advance instruction is a timing advance timer expiry command for forcing a timing advance timer to expire.

10. The apparatus according to claim 9, wherein the timing advance timer is configured for a group of component carriers on which uplink connections for the apparatus are configured and for which the at least one user equipment uses the same timing advance timer.

11. The apparatus according to claim 1, wherein the timing advance related instruction is configured for a group of secondary component carriers on which the same timing advance value is used.

12. An apparatus comprising
an interface connectable to a network, wherein an uplink connection of the apparatus is configured on at least one component carrier, the interface being configured to receive a timing advance related instruction, and
a controller configured to
change a timing advance validity with respect to the at least one component carrier in response to receiving the timing advance related instruction.

13. The apparatus according to claim 12,
wherein the controller maintains a timing advance validity status, and the timing advance related instruction is a timing advance invalidity command for setting the timing advance validity status as invalid by which the timing advance is made invalid.

14. The apparatus according to claim 12, wherein
the controller maintains a timing advance validity status, and the timing advance related instruction is a timing advance validity command for setting the timing advance status as valid by which the timing advance is made valid.

15. The apparatus according to claim 13, wherein
the interface is configured to receive a timing advance command, and the controller is configured to set the timing advance validity status as valid in response to receiving the timing advance command.

16. The apparatus according to claim 15, wherein
the timing advance command is a timing advance MAC control element or a timing advance in a random access response.

17. The apparatus according to claim 13, wherein
a timing advance value and a timing advance validity status is defined for a group of component carriers.

18. The apparatus according to claim 12,
wherein the timing advance instruction is a timing advance timer expiry command for forcing a timing advance timer to expire.

19. The apparatus according to claim 18, wherein the timing advance timer is configured for a group of component carriers on which uplink connections of the apparatus are configured.

20. The apparatus according to claim 12, wherein the timing advance related instruction is configured for a group of secondary component carriers on which the same timing advance value is used.

21. The apparatus according to claim 12, wherein the controller is configured to suspend uplink transmission when the timing advance related instruction that changes the validity of timing advance to invalid has been received.

22. The apparatus according to claim 14, wherein
the controller is configured to maintain uplink transmission resources when the timing advance related instruction that changes the validity of timing advance to valid has been received.

23. A method comprising
controlling a network including at least one user equipment, wherein an uplink connection of the at least one user equipment is configured on at least one component carrier, and
sending a timing advance related instruction with respect to the at least one component carrier to the at least one user equipment, by which validity of the timing advance is changed.

24. The method according to claim 23, wherein
the timing advance related instruction is a timing advance invalidity command for setting a timing advance validity status of the at least one user equipment as invalid, by which the timing advance is made invalid .

25.-33. (canceled)

34. A method comprising
receiving a timing advance related instruction, wherein an uplink connection is configured on at least one component carrier, and
changing a timing advance validity with respect to the at least one component carrier in response to receiving the timing advance related instruction .

35. The method according to claim 34, further comprising
maintaining a timing advance validity status, wherein the timing advance related instruction is a timing advance invalidity command for setting the timing advance validity status as invalid by which the a timing advance is made invalid.

36.-44. (canceled)

45. A computer program product comprising code means for performing a method according to claim 23 when run on a processing means or module.

46. The computer program product according to claim 45, wherein the computer program product is embodied on a computer-readable medium.
